(19) United States
(12) Patent Application Publication
(10) Pub. No.: US 2010/0205842 A1
(43) Pub. Date: Aug. 19, 2010

(54) HANGING DISPLAY TAG

(75) Inventor: Henry Halimi, Los Angeles, CA (US)

Correspondence Address: EDWARDS ANGELL PALMER & DODGE LLP, P.O. BOX 55874, BOSTON, MA, 02205, US

(73) Assignee: Watts Water Technologies, Inc., North Andover, MA (US)

(21) Appl. No.: 12/615,770

(22) Filed: Nov. 10, 2009

Related U.S. Application Data
(60) Provisional application No. 61/121,968, filed on Dec. 12, 2008.

(51) Int. Cl. G09F 3/02

(52) U.S. Cl. 40/642.01

(57) ABSTRACT

A hanging display tag for supporting a product, such as a flexible hose, includes a substantially planar body. A first opening formed in the body can extend over a horizontally extending bar of a point of sale product display area, to suspend the tag therefrom. A second opening formed in the body can retain a product such as flexible hose. The second opening includes a central opening, first slots extending from the central opening, and second slots extending from the first slots.

### CROSS-REFERENCE TO RELATED APPLICATION

This application claims priority to U.S. Provisional Patent Application No. 61/121,968 filed Dec. 12, 2008, which is incorporated herein by reference.

### FIELD OF THE DISCLOSURE

The subject disclosure relates to product display tags, and more particularly to display tags adapted to hang products, such as flexible hoses, from point of sale horizontal bars for presentation to potential consumers in an orderly manner.

### BACKGROUND OF THE RELATED ART

Flexible hoses are used in a large variety of applications such as in connecting, dishwashers, ice makers, faucets, washing machines, and toilets to water supplies. Often, homeowners and professionals undertake replacement of the hoses to prevent or fix leakage. As such, hardware stores stock ample supplies of a variety of flexible hoses in the plumbing section. Because the typical applications have different requirements, a large variety of hose lengths, diameters and couplings are needed.

Conventional flexible hose display mechanisms include a vertical board (i.e., peg board) with horizontal bars extending from the board. Each flexible hose is secured to a cardboard display tag that defines a hole for passing onto one of the horizontal bars. Some of the cardboard display tags may also include one or even two pairs of opposing circular holes for securing the hose. By passing wires or tie wrap through the opposing holes and around the hose, the hose is secured to the display tag. Other display tags may include openings that are slipped over an end fitting of the flexible hose, yet retain the end fitting such that the hose hangs from the display tag. Some display tags must be attached to the hose during assembly of the hose, and then torn or cut off by the customer after the hose has been purchased.

There are problems associated with these types of display tags. For example, the wires or tie wrap not only add to the cost and complexity but removal after purchase can be a difficult and frustrating task. What is still desired is a hanging display tag for a flexible hose that is simple and cost effective to manufacture, prevents inadvertent removal and proper display of the hose, can be attached to the hose anytime after final assembly of the hose, and is easily removed after purchase of the hose.

### SUMMARY OF THE DISCLOSURE

The present disclosure is directed to a hanging display tag including a substantially planar body. A first opening formed in the body can extend over a horizontally extending bar to suspend the tag therefrom. A second opening formed in the body can retain a flexible hose having two ends with end fitting attached thereto. The second opening includes a central opening, first slots that extend from the central opening, and second slots that entend from the first slots.

According to one exemplary embodiment, the first slots are defined by a rounded end portion and two opposing parallel sides that extends from the central opening to the rounded end portion. In another exemplary embodiment, two opposing sides of each of the first slots extends from the central opening to the rounded end portion at an angle such that the first slots narrow towards the rounded ends.

In an additional exemplary embodiment, each of the second slots defines a central axis and the second slots are oriented with respect to each other such that an intersection of the two central axes of the second slots is approximately at a bottom edge of the central opening of the second opening.

The present disclosure, therefore, provides a hanging display tag for a flexible hose that is simple and cost effective to manufacture, prevents inadvertent removal and proper display of the hose, can be attached to the hose anytime after final assembly of the hose, and is easily removed after purchase of the hose. Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is a perspective view of exemplary embodiments of water connectors shown coupled to a faucet and a drain of a sanitary appliance comprising a sink;

FIG. 2 is an elevation view of one of the connectors of FIG. 1, wherein the connector includes a reinforced flexible hose extending between end fittings;

FIG. 3 is a front elevation view of an exemplary embodiment of a hanging display tag constructed in accordance with the present disclosure;

FIG. 4 is a rear perspective view of the hanging display tag of FIG. 3;

FIG. 5 is an enlarged view of a portion of the hanging display tag of FIG. 3;

FIG. 6 is an enlarged side view, partially in section, illustrating the hanging display tag of FIG. 3 shown attached to an end of a flexible connector hose, such as the hose of FIG. 2;

FIG. 7 is a front elevation view of the hanging display tag of FIG. 3 shown attached to the flexible connector hose; and

FIG. 8 is a rear elevation view of the hanging display tag of FIG. 3 shown attached to the flexible connector hose.

### DETAILED DESCRIPTION OF EXEMPLARY EMBODIMENTS

The present disclosure provides hanging display tags for use with flexible connector hoses. The display tags allow a large variety of hoses to be displayed in retail and wholesale setting for customers to view and purchase. The connector hoses can be of any type that include a hose secured to an end fitting, such that the end fitting can be captured by the hanging display tag with the hose hanging downward from the tag. The presently disclosed hanging display tags can be used with many different types of hoses, including gas hoses, air hoses, water hoses, reinforced hoses, and non-reinforced hoses.

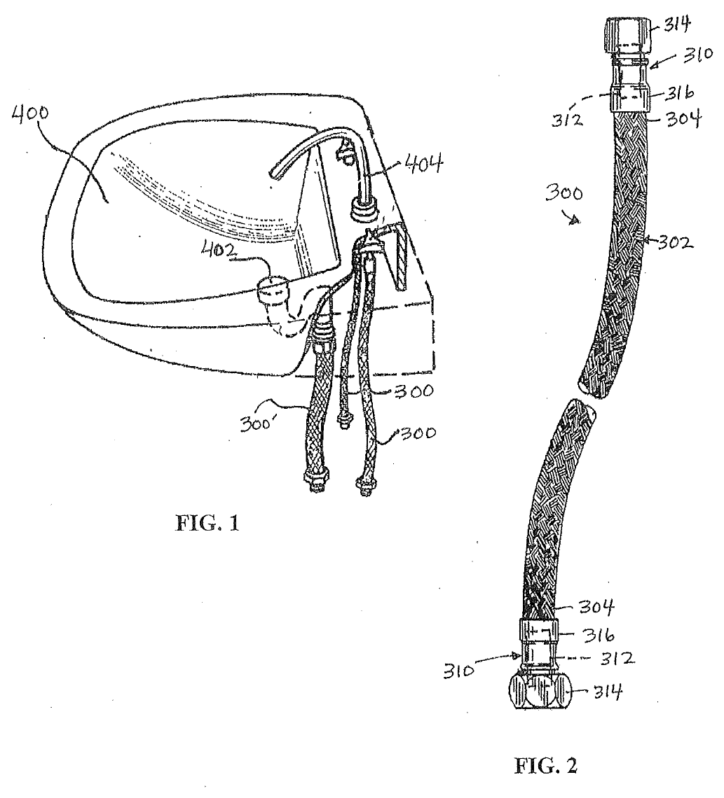

Referring to FIGS. 1 and 2, an exemplary embodiment of a water connector hose 300 constructed in accordance with the prior art, and that can be used with the hanging display tag of the present disclosure, is shown. As illustrated in FIG. 1, the connector hose 300 is adapted for use with sanitary appliances, such as a sink 400. The connector hose 300 can be provided in different sizes, such as a larger diameter connector hose 300′ for connection to a drain 402 of the sink 400 and smaller diameter connector hoses 300 for connection to a faucet 404 of the sink 400.

Referring to FIG. 2, the connector hose 300 includes a reinforced flexible hose 302 extending between end fittings 310. In the exemplary embodiment shown, the end fittings 310 comprise a hose barb 312 received into ends 304 of the hose 302, a swivel nut 314 secured on the hose barb 312, and a ferrule 316 received over the hose end 304 and crimped to secure the hose end 304 between the ferrule 316 and the barb 312.

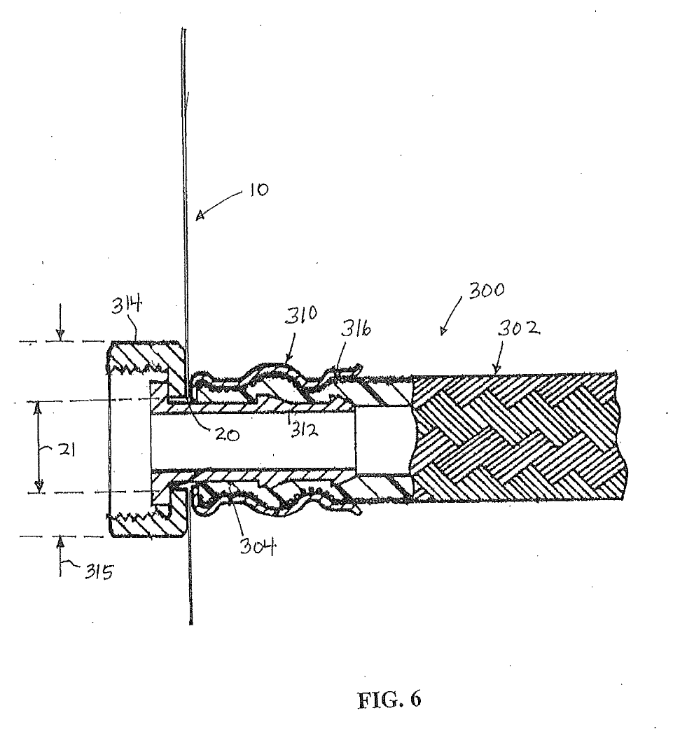

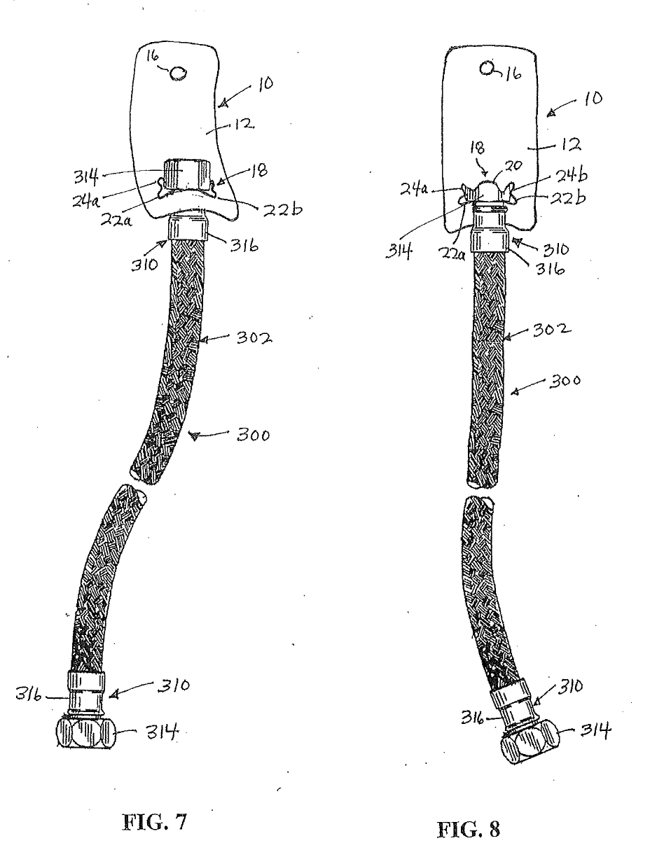

Referring now to FIGS. 3-8, there is shown an exemplary embodiment of a hanging display tag 10 according to the present disclosure. The hanging display tag 10 has a substantially planar body 12, which may include promotional markings such as a trademark, product name, detailed product specifications, and the like. The body 12 has a vertical center line or longitudinal axis 14 with top and bottom openings 16, 18. The top opening 16 is sized and configured to pass over a horizontally extending bar (not shown), such as a bar that extends from a peg board used in a store display. The bottom opening 18 is sized and configured to retain the end fitting 310 of the flexible connector hose 300 to the body 12 without additional connecting means. As the end fitting 310 is normally of a larger diameter than the flexible hose 302, a shoulder is formed at the junction between the flexible hose 302 and the end connector 310. In the examplary embodiment shown, the swivel nut 314 comprises the shoulder, as is shown in FIGS. 6-8. It is this shoulder 314 that is utilized by the bottom opening 18 to retain the connector hose 300 to the display tag 10. By centering the top and bottom openings 16, 18 on the longitudinal axis 14, the display tag 10 is balanced when hung from a horizontal bar. In FIGS. 7 and 8 the hose 300 is shown hanging from the display tag 10.

As shown best in FIGS. 3-5, the bottom opening 18 is a circular central hole 20 with first slots 22a, 22b extending from the central hole 20. The central hole 20 has a radius 21 that is sized to be smaller than a radius 315 of the swivel nut 314 of the connector hose 300, as is shown in FIG. 6.

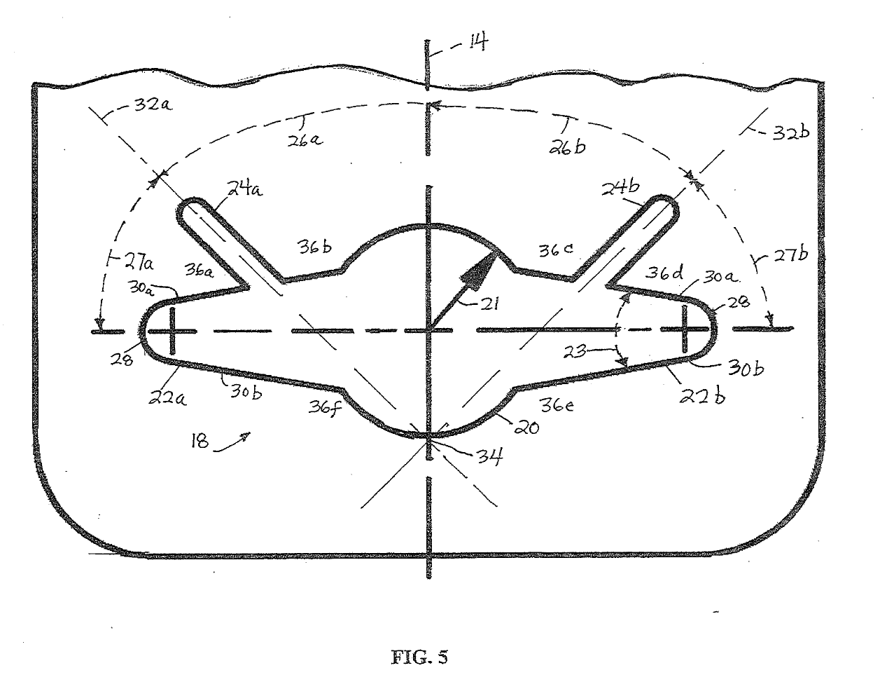

Referring back to FIGS. 3-5, the first slots 22a, 22b are opposed and extend approximately horizontally, e.g., perpendicularly to the longitudinal axis 14. The bottom opening 18 also has second slots 24a, 24b that extend from the first slots 22a, 22b and are at angles 26a, 26b with respect to the longitudinal axis 14. In one embodiment, the angles 26a, 26b of the second slots 24a, 24b are approximately plus and minus forty-five degrees (45°) from the longitudinal axis 14, as shown in FIGS. 3 and 5. Preferably, each slot 24a, 24b defines a central axis 32a, 32b such that an intersection 34 of the two central axis 32a, 32b is approximately at a centered bottom edge of the central hole 20. As a result, the bottom opening 18 provides excellent retention that may be engaged repeatedly while still maintaining a secure retention of the desired item. As shown best in FIG. 5, the second slots 24a, 24b also extend at angles 27a, 27b with respect to the first slots 22a, 22b of approximately forty-five degrees (45°).

The first slots 22a, 22b are defined by a rounded end portion 28 and two opposing sides 30a, 30b that increasingly separate away from the rounded end portion 28 such that the slots 22a, 22b expand at an angle 23 such that the slots are wider at the central hole 20, as shown best in FIG. 5. According to one exemplary embodiment, the angle 23 is equal to about twenty degrees (20°). Alternatively, the two opposing sides 30a, 30b can extend parallel to one another between the end portion 28 and the central hole 20.

As shown in FIGS. 3-5, the second slots 24a, 24b extend upwardly from the sides 30a of the first slots 22a, 22b. Alternatively, the second slots 24a, 24b may extend downward from the sides 30b of the first slots 22a, 22b. In still other embodiments, one pair of second slots may extend upward from the sides 30a of the first slots 22a, 22b and another pair of second slots may extend downward from the sides 30b of the first slots 22a, 22b. In still another embodiment, one or two pairs of second slots may extend from the central hole.

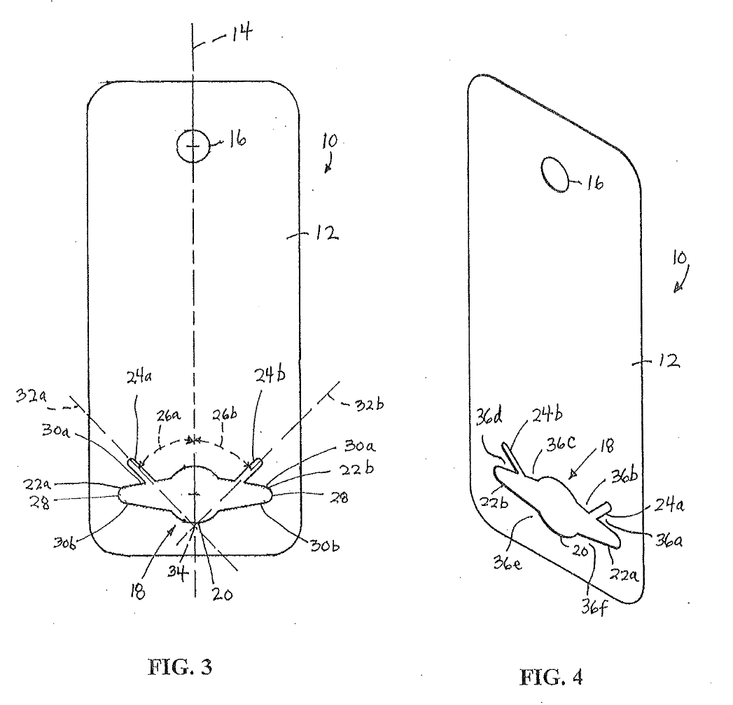

As can best be seen in FIGS. 4 and 5, the configuration of the bottom opening 18 creates resiliently deflectable lands 36a-f of the body 12. The flexible hose may be repeatedly inserted and removed from the bottom opening 18. When inserted in the bottom opening 18, the flexible hose is securely retained without the need for additional connecting means such as wire wrapping.

Thus, the present disclosure provides a new and improved hanging display tag for flexible hoses. It should be understood, however, that the exemplary embodiments described in this specification have been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the improved display tag disclosed herein, and all elements thereof, are contained within the scope of at least one of the following claims. No elements of the presently disclosed display tag are meant to be disclaimed.

What is claimed is:

1. A hanging display tag comprising:
a substantially planar body defining:
a longitudinal axis;
a first opening for passing over a horizontally extending bar; and
a second opening for retaining a flexible hose having two ends with fluid couplings attached thereto, the second opening including a central hole with first slots that are approximately perpendicular to the longitudinal axis and second slots that are at an angle to the longitudinal axis.

2. A hanging display tag as recited in claim 1, wherein the angle is approximately 45 degrees.

3. A hanging display tag as recited in claim 1, wherein the longitudinal axis passes through a center point of the first and second openings.

4. A hanging display tag as recited in claim 1, wherein the first slots are defined by a rounded end portion and two opposing parallel sides.

5. A hanging display tag as recited in claim 1, wherein the first slots are defined by a rounded end portion and two opposing sides that increasingly separate away from the rounded end portion.

6. A hanging display tag as recited in claim 1, wherein the second slots extend from the first slots.

7. A hanging display tag as recited in claim 1, wherein each of the second slots extends along a central axis and the second slots are oriented such that an intersection of the two central axes is approximately at a bottom edge of the second opening.

8. A hanging display tag as recited in claim 1, wherein the body includes promotional markings.

9. A hanging display tag as recited in claim 1, wherein the central hole is circular.

10. A hanging display tag as recited in claim 9, wherein a radius of the central hole is smaller than a radius of shoulder formed by a end fitting of a connector hose supported by the tag.

11. A hanging display tag for retaining a flexible hose having two ends with fluid couplings attached thereto such that a shoulder is faulted at a juncture of the end and the coupling, the hanging tag display comprising:
a substantially planar body defining a first opening for passing over a horizontally extending bar and a second opening for coupling to the shoulder,
wherein the second opening includes a central hole with at least one slot extending from the central hole to create resiliently deflectable lands for capturing the shoulder of the flexible hose.

12. A hanging display tag as recited in claim 11, wherein the at least one slot is an opposing pair of first slots that extend transverse to a longitudinal axis of the body and an opposing pair of second slots that extend from the first slots at an angle with respect to the longitudinal axis.

13. A hanging display tag as recited in claim 12, wherein the angle is approximately 45 degrees.

14. A hanging display tag as recited in claim 12, wherein the first slots are defined by a rounded end portion and two opposing parallel sides.

15. A hanging display tag as recited in claim 12, wherein the first slots are defined by a rounded end portion and two opposing sides that increasingly separate away from the rounded end portion towards the central opening.

16. A hanging display tag as recited in claim 12, wherein each of the second slots extends along a central axis and the second slots are oriented such that an intersection of the two central axes is approximately at a bottom edge of the second opening.

17. A hanging display tag as recited in claim 12, wherein the second slots extend from a top side of the first slots.

18. A hanging display tag as recited in claim 11, wherein a radius of the central hole is smaller than a radius of the shoulder of the connector hose.

19. A hanging display tag as recited in claim 11, wherein a longitudinal axis of the body of the tag passes through a center point of the first and second openings.

20. A hanging display tag as recited in claim 11, wherein the body includes promotional markings.
